(19) United States
(12) Patent Application Publication
(10) Pub. No.: US 2018/0214334 A1
(43) Pub. Date: Aug. 2, 2018

(54) System and Method for Joint Treatment

(71) Applicant: Leonid TAFLER, Brooklyn, NY (US)

(72) Inventor: Leonid TAFLER, Brooklyn, NY (US)

(21) Appl. No.: 15/939,037

(22) Filed: Mar. 28, 2018

(51) Int. Cl. A61H 1/02; A61H 1/00

(52) U.S. Cl. CPC A61H 1/0222; A61H 1/006; A61H 2201/1642; A61H 2205/10; A61H 2201/0192; A61H 2201/5007; A61H 1/024; A61H 1/0244; A61H 1/0255

(57) ABSTRACT

A system and a method are for applying a predetermined tension to a joint of a limb of a patient. The limb includes a first limb portion and a second limb portion connected on opposite sides of the joint. The system may include a first securing structure including a first coupling element configured to be coupled to the first limb portion and a first tension member extending from the first coupling element to be anchored in a position selected to secure the first limb portion in a desired position; a second securing structure including a second coupling element configured to be coupled to the second limb portion and a second tension member extending from the second coupling element and connected to a tensioning device for applying a predetermined tensioning force to the joint along an axis of the second limb portion.

### BACKGROUND INFORMATION

Joint injuries may occur through overuse, over stretching, or trauma. Most common injuries, such as Runner's Knee or sprained ankle, are caused by individuals hyperextending their joint. Symptoms of injuries can include swelling and tenderness. Basic treatments rely on ice packs and heating pads to calm the swelling and allow the joint to heal itself. For more serious injuries, specific devices could be used for treatment. Numerous devices have been created for treatment of an injured joint. These devices require immobilization of a patient for a duration of a procedure. Most of such devices use elastic bands and machines that pull on and stretch out the joint. When a joint is stretched, muscles attached to it are also stretched, producing microtears within them. The microtears heal and the muscles become stronger. Stronger muscles help the joint absorb more shock, consequently giving it a greater range of mobility, durability, and overall strength.

### SUMMARY

Exemplary embodiments of the present disclosure relate to a system and a method for a joint treatment. In particular, one of the exemplary embodiments relates to a system for applying a predetermined tension to a joint of a limb of a patient. The limb includes a first limb portion and a second limb portion connected on opposite sides of the joint. The system may include a first securing structure including a first coupling element configured to be coupled to the first limb portion and a first tension member extending from the first coupling element to be anchored in a position selected to secure the first limb portion in a desired position; a second securing structure including a second coupling element configured to be coupled to the second limb portion and a second tension member extending from the second coupling element and connected to a tensioning device for applying a predetermined tensioning force to the joint along an axis of the second limb portion.

Another one of the exemplary embodiments relates to a system which may include a securing arrangement for securing a first limb portion and a second limb portion connected to one another via a knee joint in a desired position, the securing arrangement including a first securing structure configured to be coupled to the first limb portion and a second securing structure configured to be coupled to the coupled to the second limb portion, the first securing structure including a first tension member anchored in a selected position to hold the first limb portion in the desired position; and a tensioning device for applying a tensioning force to the knee, the tensioning device applying the tensioning force via a second tension member connecting the tensioning device to the second securing structure along an axis of the second limb portion.

Yet another one of the exemplary embodiments relates to a method for treating a knee joint of a leg of a patient, which may include the following: laying the patient on a surface of a table in a supine position; bending a hip joint of the leg at an approximately 90-degree angle and positioning a first coupling element along a posterior surface of a thigh of the patient proximate the knee joint; anchoring a first tension member, which is connected to the first coupling element, to a selected point to maintain the thigh in the hip joint in the bent position; bending the knee joint of the patient at an approximately 90-degree angle and positioning a second coupling element to a lower portion of the leg of the patient; and applying a tensioning force to the knee joint along an axis of the lower portion of the leg using a tensioning device connected to the second coupling element via a second tension member.

### BRIEF DESCRIPTION OF THE DRAWINGS

FIG. 1 shows a system according to the exemplary embodiments.

FIG. 2 shows a partial view of the system shown in FIG. 1 according to the exemplary embodiments.

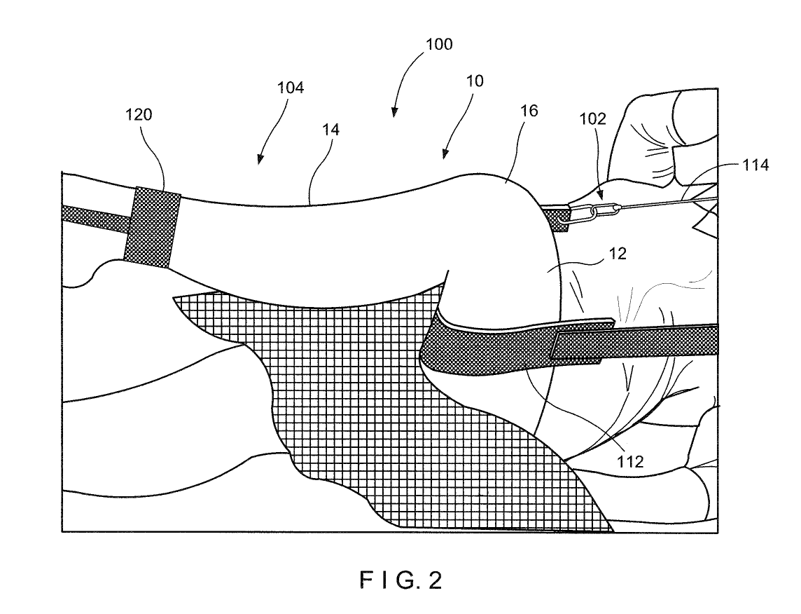

### DETAILED DESCRIPTION

The exemplary embodiments may be further understood with reference to the following description and the related appended drawings, wherein like elements are provided with the same reference numerals. The exemplary embodiments are related to a device, a system, and a method for treating a joint of a limb that is generally comprised of a first limb portion and a second limb portion connected to one another via the joint. In particular, exemplary embodiments describe a system and method for applying a tension to a joint by securing the first limb portion and the second limb portion in a desired position and orientation relative to one another. Although the exemplary embodiments specifically show and describe a knee joint, it will be understood by those of skill in the art that the embodiments of the present disclosure may be similarly applied to the treatment of other joints of the body.

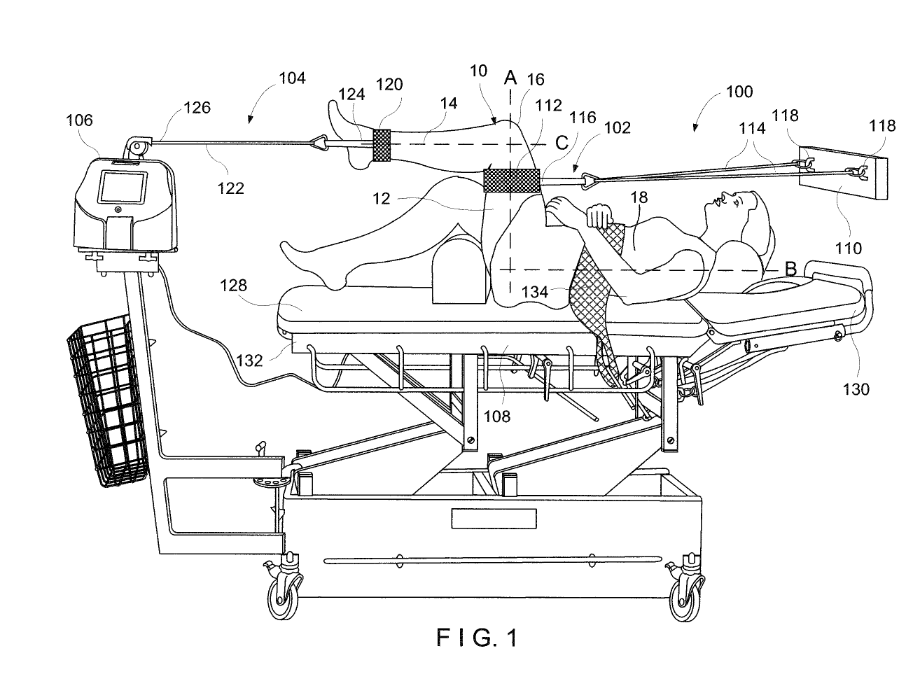

As shown in FIG. 1, a system 100 for a joint treatment of a patient according to an exemplary embodiment of the present disclosure. The system 100 may comprise a first securing structure 102 configured to be coupled to a first limb portion 12 (e.g., thigh) of a limb 10 and a second securing structure 104 configured to be coupled to a second limb portion 14 (e.g., lower leg) of the limb 10 so that a target joint 16 (e.g., the knee) connecting the two limb portions 12, 14 may be held in a desired configuration. A tensioning device 106 such as, for example, a computerized traction unit, is connectable to the second securing structure 104 so that a tensioning force may be applied to the target joint 16. For example, for the treatment of a knee joint, it may be desired to hold the first and second limb portions 12, 14 at an approximately 90-degree angle relative to one another so that, when a force is exerted on the second securing structure 104 via the tensioning device 106, a tension is applied directly to the target joint 16. As it will be understood by those of skill in the art, the leg, for example, is comprised of and is connected to the other portions of the body via a variety of joints—e.g., hip joint, ankle joint. In an exemplary embodiment, the system 100 may prevent, or at least minimize, any tension applied to other non-target joints of the body so that treatment is targeted to the target joint of the patient. The system 100 may further comprise a traction table 108 or other surface on which the patient may lay to secure the first and second limb portions 10, 12.

The first securing structure 102 includes a first coupling 112 for connecting to the first limb portion 12 and a first tension member 114 extending from the first coupling 112 to secure the first limb portion 12 in a desired position relative to the second limb portion 14 and/or a portion of the patient body 18 (e.g., upper body—torso) laying on the traction table 108 or other surface. The first coupling 112 may, for example, be configured as a band, strap or other element extending about a portion of the first limb portion 12. The first tension member 114 extends from a first end 116 connected to the first coupling 112 to a second end 118 that may be anchored to, for example, a rail 110 at a head end 130 of the traction table 108 or a wall adjacent to the head end 130 of the traction table 108.

Although the first tension member 114 is described as being anchored to the rail 110 or a wall, it will be understood by those of skill in the art that the second end 118 may be anchored to any of a variety of structures in any of a variety of ways so long as the second end 118 is anchored in such a way as to apply a tension to the first coupling 112 so that the first limb portion 12 is secured in the desired position relative to the second limb portion 14 and/or the upper body of the patient. In one exemplary embodiment, in the desired position, the first securing structure 102 holds the first limb portion 12 such that a longitudinal axis A along which the first limb portion 12 extends is at an angle of between 70 and 110 degrees relative to a longitudinal axis B along which a portion of the body 18—e.g., torso—that remains laying on the table 108 extends. In a particular embodiment, the thigh extends at an angle of approximately 90-degrees relative to the upper body, in the desired configuration. In other words, the first securing structure 102 holds the first limb portion 12 such that the longitudinal axis A of the first limb portion 12 extends at an approximately 90-degree angle relative to a surface of the table 108.

In one exemplary embodiment, the first coupling element 112 is positioned along a portion of the first limb proximate the target joint 16. It will be understood by those of skill in the art that placing the coupling element 112 closer to the knee joint will provide the most stable securement of the first limb in the desired position. It will also be understood by those of skill in the art, however, that the first coupling element 112 may be placed in any of a variety of positions along the first portion of the limb 12 between the hip joint and the knee joint so long as the first securing structure 102 is able to secure the first limb portion 12 in the desired configuration. The first tension member 114 may have any of a number of configurations including, for example, a wire, rope, cable, or other element capable of withstanding sufficient tension to hold the first limb portion 12 in the desired position.

The first tension member 114 may be tensioned by adjusting a length of the first tension member 114 extending between the strap and the rail 110 or wall. Alternatively, the tension table 108 may be moved toward or away from the wall to which the first tension member 114 is anchored to adjust the tension thereon. In one embodiment, the first tension member 114 may extend substantially parallel to the tension table 108 or other surfaces on which the patient is laying. It will be understood by those of skill in the art, however, that this is not required so long as the first tension member 114 is able to withstand sufficient tension to hold the first limb 12 in the desired configuration. In one embodiment, in which the first coupling element 112 is configured as, for example, a strap, the strap may be positioned along the posterior side of the thigh, near the knee joint so that the first tension member 114 extends from the strap in a superior direction, towards a head of the patient. In this embodiment, the first tension member 114 may include, for example, a pair of cables, wire element, or lengths of rope, each of which extend from opposite ends of the strap.

The wall or rail 110 may include a number of anchoring points therealong via which the second end 118 of the first tension member 114 may be anchored so that a height at which the first securing structure 102 is anchored to the wall or rail 110 is adjustable to specific proportions of the patient. For example, a length of a thigh may vary from patient to patient so that a point at which the second end 118 of the first tension member 114 is anchored should be adjustable to provide optimal securement in the desired configuration. Alternatively, a height of the traction table 108 or other surface on which the patient is laying may be adjusted to accommodate for the specific proportions of the patient.

The second securing structure 104 includes a second coupling element 120 configured to be coupled to the second limb portion 14 and a second tension member 122 for connecting the second coupling element 120 to the tensioning device 106. The second coupling element 120 may be configured as, for example, a strap, band or belt configured to be fastened to a portion of the second limb portion 14. The second coupling element 120 may, for example, be configured to extend about a circumference of the second limb portion 14 and may be adjustable to accommodate various limb proportions. For example, the second coupling element 120 may include a hook and loop closure which permits a circumference accommodated by the second coupling element 120 to be adjustable. It will be understood by those of skill in the art, however, that the second coupling element 120 may have any of a variety of closure mechanisms permitting varying limb proportions (e.g., leg circumference).

The second tension member 122 may extend from a first end 124 coupled to the second coupling element 120 to a second end 126 connected to the tensioning device 106. The second tension member 122 may be positioned so that the second limb portion 14 is secured at an angle of between approximately 70 and 110-degrees relative to the first limb portion 12. In a more specific embodiment, the second limb portion 14 is secured at an angle of approximately 90-degrees relative to the first limb portion 12. In other words, the second securing structure 104 is secured to the second limb portion 14 and tensioned so that a longitudinal axis C along which the second limb portion 14 extends is at an angle of between approximately 70 and 110-degrees relative to the longitudinal axis A long which the first limb portion 12 extends. The angle of second limb portion 14 relative to the first limb portion 12 may be adjusted by, for example, adjusting a height of the tensioning device 106 and/or adjusting a height of the traction table 108 on which the patient is laying. Similarly to the first tension member 114, the second tension member 122 may be configured as a wire, rope, cable or other similar element capable of withstanding a desired tension being applied to the target joint 16 via the second tension member 122.

In one embodiment, the second coupling element 120 is secured about a portion of the second limb portion 14 away from the target joint 16. It will be understood by those of skill in the art that the second coupling element 120 may be positioned along any portion of the second limb 14 between, for example, the knee joint and the ankle joint. The second tension member 122 extends from the second coupling element 120 in an inferior direction to the tensioning device 106, which may be positioned proximate a foot end 132 of the traction table 108.

The traction table 108 includes a surface 128 on which the patient may lay, the surface 128 extending longitudinally from the head end 130 to a foot end 132. As described above, the head end 130 of the traction table 108 may include rails 110 to which the second end 118 of the first tension member 114 may be anchored. The rails 110 may include various anchoring points therealong for providing varying heights at which the second end 118 of the first tension member 114 may be anchored so that the system 100 is adjustable for patients having different proportions. The traction table 108 may also include a securing mechanism 134 for securing the patient to the table 108. This securing mechanism 134 may include, for example, a belt or strap extending about the upper body of the patient to secure the patient in a fixed position relative to the table 108. Thus, the securing mechanism 134 provides additional securement of the patient when tension is being applied to the target joint 16. It will be understood by those of skill in the art that the traction table 108 may have any of a variety of configurations. In one embodiment, the table 108 may include wheels for moving the table 108 toward and away from walls including rails 110 and/or the tension device 106. Alternatively, the table 108 may remain stationary while rails 110 and/or anchoring points of the first tensioning member 114 and/or a position of the tensioning device 106 is adjusted. As described above, a height of the table 108 and/or the surface 128 and/or a height of the tensioning device 106 may also be adjustable, as necessary.

According to an exemplary method using the system 100, the patient may lay on the surface 128 of the traction table 108 in a supine position along a length of the table so that the patient's head is positioned proximate the head end 130 of the table 108 and the patient's legs extend toward the foot end 132. The patient may then bend the first limb portion 12 at an approximately 90-degree angle relative to the patient's upper body and/or the surface 128 of the traction table 108 so that the first coupling element 112 may be coupled to the first limb portion 12. In an embodiment in which the system 100 is used to treat a knee joint, the patient may bend his unilateral hip so that the first coupling element 112 may be positioned along a posterior side of the thigh proximate the knee joint. The first tension member 114, with the first end 116 thereof connected to the first coupling element 112, is tensioned and anchored to the rail 110, or a wall adjacent the head end 130, at the second end 118 so that the first limb portion 112 is secured in the desired position—e.g., at an approximately 90-degree angle relative to the upper body and/or table surface 128.

The patient may bend the second limb portion 14 at an approximately 90-degree angle relative to the first limb portion 12 so that the target knee joint 16 is bent at the approximately 90-degree angle. The second securing structure 104 may then be used to secure the second limb portion 14 in this desired position relative to the first limb portion 12 by coupling the second coupling element 120 to a portion of the second limb joint 14. The second coupling element 120 may, in one example, be secured to the second limb portion 14 along a portion thereof, which extends away from the knee joint. In one particular embodiment, the second coupling element 120 may be coupled to a portion of the second limb portion 14 proximate the ankle joint. A position and/or tension along the second tension member 122, which extends from the second coupling element 120 to connect to the tensioning device 106, holds the second limb portion 14 in the desired position.

Once the first and second limb portions 12, 14 have been secured, as desired, the tensioning device 106 is used to apply an increased tension to the second tension member 122, thereby applying a tensioning force to the target joint 16 along an axis of the second tension member 122 and an axis of the second limb portion 14. The tensioning force stretches the knee joint to provide treatment thereto. It will be understood by those of skill in the art that the tensioning device 106 may provide a predetermined traction force to the target joint 16 for a desired amount of time. This predetermined traction force may be adjusted as needed and may be pre-programmed into a processing unit of the tensioning device 106. It will also be understood by those of skill in the art that the “stretching” treatment described above may be combined with other physical therapeutic modalities including, for example, electrical stimulation.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed is:

1. A system for applying a predetermined tension to a joint of a limb of a patient, the limb including a first limb portion and a second limb portion connected on opposite sides of the joint, comprising:
a first securing structure including a first coupling element configured to be coupled to the first limb portion and a first tension member extending from the first coupling element to be anchored in a position selected to secure the first limb portion in a desired position; and
a second securing structure including a second coupling element configured to be coupled to the second limb portion and a second tension member extending from the second coupling element and connected to a tensioning device for applying a predetermined tensioning force to the joint along an axis of the second limb portion.

2. The system of claim 1, wherein the first limb portion and the second limb portion are secured at a predetermined angle relative to one another in the desired position.

3. The system of claim 2, wherein the predetermined angle is approximately a 90-degree angle.

4. The system of claim 1, wherein the tensioning device is a computerized traction device.

5. The system of claim 1, further comprising a table positionable relative to the first and second securing structures and providing a surface for the patient to lay.

6. The system of claim 1, wherein the table includes a rail extending from a head end thereof, the railing including at least one anchoring point at which the first tension member is anchorable to secure the first limb portion in the desired position.

7. The system of claim 1, wherein the first coupling element includes a strap and the first tension member includes a pair of longitudinal elements extending from opposite ends of the strap to be anchored in the selected position.

8. The system of claim 1, wherein second coupling element includes a belt configured to extend about the second limb portion.

9. The system of claim 1, wherein the first tension member and the second tension member include one of a rope, cable and wire.

10. A system, comprising:
a securing arrangement for securing a first limb portion and a second limb portion connected to one another via a knee joint in a desired position, the securing arrangement including a first securing structure configured to be coupled to the first limb portion and a second securing structure configured to be coupled to the coupled to the second limb portion, the first securing structure including a first tension member anchored in a selected position to hold the first limb portion in the desired position; and
a tensioning device for applying a tensioning force to the knee, the tensioning device applying the tensioning force via a second tension member connecting the tensioning device to the second securing structure along an axis of the second limb portion.

11. The system of claim 10, wherein the first and second limb portions extend at an approximately 90-degree angle relative to one another in the desired position.

12. The system of claim 10, further comprising a table positionable relative to the first and second securing structures and providing a surface for the patient to lay.

13. The system of claim 12, wherein the table includes a rail extending from a head end thereof, the rail including at least one anchoring point at which the first tension member is anchorable to secure the first limb portion in the desired position.

14. The system of claim 12, wherein the table includes a securing mechanism for securing the patient in a position relative to the table.

15. The system of claim 10, wherein the first securing structure includes a strap configured to be positioned along a portion of the first limb portion proximate the knee joint.

16. The system of claim 10, wherein the second securing structure includes a belt configured to be positioned along a portion of the second limb portion proximate an ankle joint of the second limb portion.

17. A method for treating a knee joint of a leg of a patient, comprising:
laying the patient on a surface of a table in a supine position;
bending a hip joint of the leg at an approximately 90-degree angle and positioning a first coupling element along a posterior surface of a thigh of the patient proximate the knee joint;
anchoring a first tension member, which is connected to the first coupling element, to a selected point to maintain the thigh in the hip joint in the bent position;
bending the knee joint of the patient at an approximately 90-degree angle and positioning a second coupling element to a lower portion of the leg of the patient; and
applying a tensioning force to the knee joint along an axis of the lower portion of the leg using a tensioning device connected to the second coupling element via a second tension member.
